(19) United States
(12) Patent Application Publication
(10) Pub. No.: US 2015/0303006 A1
(43) Pub. Date: Oct. 22, 2015

(54) ON-LOAD TAP CHANGER

(71) Applicant: MASCHINENFABRIK REINHAUSEN GMBH, Regensburg (DE)

(72) Inventors: Alfred BIERINGER, Geiselhoering (DE); Christian HAMMER, Regensburg (DE); Rolf STREMPEL, Regensburg (DE)

(21) Appl. No.: 14/383,996

(22) PCT Filed: Mar. 25, 2013
(86) PCT No.: PCT/EP2013/056276

§ 371 Date: Sep. 9, 2014

(30) Foreign Application Priority Data
Apr. 20, 2012 (DE) 202012101476.9

(51) Int. Cl. H01H 9/00

(52) U.S. Cl. CPC H01H 9/0011; H01H 9/0027; H01H 9/0038

(57) ABSTRACT

The invention relates to an on-load tap changer for switching among different winding taps of a step transformer without interruption according to the preamble of the first patent claim. The general inventive concept lies in actuating both the selector contact unit and the switching means for uninterrupted load switching by means of a common motor drive without an energy store being connected therebetween.

The present invention relates to an on-load tap changer for uninterrupted switching between different winding taps of a tapped transformer in accordance with the preamble of the first claim.

On-load tap changers have been in use worldwide on a large scale for many years for uninterrupted switching between different winding taps of tapped transformers. So-called reactor switches, which are particularly widespread in North America, have a switch-over reactance that enables a slow, continuous switching. On-load tap changers according to the resistance fast switching principle usually consist of a selector for power-free selection of the respective winding tap of the tapped transformer that is to be switched to and a load changeover switch for the actual changing over from the previous to the new, preselected winding tap. The load changeover switch for that purpose usually comprises switch contacts and resistance contacts. The switch contacts in that case serve for direct connection of the respective winding tap with the load diverter and the resistance contacts for temporary connection, i.e. bridging-over by one or more switching resistances. However, developments in recent years have led away from load changeover switches with mechanical switching contacts in insulating oil. Instead, vacuum interrupters are increasingly employed as switching elements.

An on-load tap changer of that kind with vacuum interrupters is disclosed in, for example, DE 10 2009 043 171 [US 2012/0139510]. Here, a load changeover switch carries a drive shaft, which is drivable by an energy accumulator, with at least one cam disc. The cam disc has a plurality of cams, wherein two cams arranged at the cam disc at the end have a profile, which departs from a circular shape, in the form of lobes at which a respective roller, which is connected with a vacuum interrupter by way of a rocker arm and that scans the profiled contour of the respective cam, is guided with maintained contact.

In one specific category of on-load tap changer, i.e. so-called load selectors, the described means for selection of a new winding tap and the means for the actual load changeover are constructionally combined and actuated in common. Tap changers according to the principle of resistance fast switching for uninterrupted switching from one winding tap at the tapped transformer to another are usually constructed so that the respective fixed tap contacts electrically connected with the output lines of the tap windings are arranged in one or more horizontal planes circularly at an insulating-material frame or cylinder and are connectable by rotatable contact bridges actuated by concentric drive shafts. In the case of load selectors in which the tap selection and the actual load switching are combined, actuation of the contact bridges in that case takes place abruptly after triggering of an energy accumulator, usually a spring-force store, drawn up by the drive shaft of the switch. In departure from these usual constructions, a tap changer with linear contact actuation is described in DE 42 37 165 [U.S. Pat. No. 5,523,674], wherein the fixed tap contacts extend along a track in the interior of the switch and are connectable by a displaceable switching mechanism that in turn is driven by the drive shaft. The vertically displaceable switching mechanism in that case consists of a draw-up carriage that is continuously drivable by the drive shaft and that preselects the new fixed tap contact, and a drive output part that can be drawn up by the draw-up carriage by an energy accumulator and that after triggering abruptly runs after the draw-up carriage and in that case executes the actual load changeover from the previous tap of the tapped winding to the preselected new tap. The switch elements required for that purpose are a component of the output drive part. A further on-load tap changer, which is attributable to the applicant, with linearly arranged selector contacts has become known from DE 198 47 745 [U.S. Pat. No. 5,523,674]. Disposed above the selector contacts, thus locally separated, are the stationary vacuum interrupters that are associated with the respective selector contacts of each phase, for the actual, abrupt load changeover. A spring energy accumulator is necessary for actuation of this on-load tap changer, which store actuates the selector contacts during its drawing up movement as well as the vacuum switching elements by its abrupt drive output movement.

Regardless of the constructional form of the on-load tap changer, thus with rotating or linearly movable contact system, a spring-energy accumulator for abrupt switching by the contact system is needed in on-load tap changers known from the prior art. Energy accumulators known from the prior art have to be drawn up, i.e. stressed, at the start of each actuation of the on-load tap changer by a drive shaft. The known energy accumulators essentially consist of a draw-up carriage and a jump carriage, between which force-storage springs as energy accumulators are arranged. Energy accumulators of that kind can be inferred from, for example, DE 198 55 860 and DE 28 06 282 [GB 2,014,794).

An initial slow rotational movement of the drive shaft is employed so as to translationally draw up a draw-up carriage in order to subsequently transfer the again translational movement of the jump carriage into a rotational main movement of the drive output shaft and into an actual contact actuation connected therewith. This complicated conversion of a rotational movement into a translational movement and back again into a rotational movement requires a large amount of space for the energy accumulator construction within the on-load tap changer and in addition a multiplicity of complex individual subassemblies.

The object of the present invention is therefore to indicate an on-load tap changer that dispenses with the complicated construction of an energy accumulator and thus offers a significantly simplified form of construction with, at the same time, increased operational reliability.

This object is fulfilled by an on-load tap changer for uninterrupted switching between different winding taps of a tapped transformer with the features of the first claim. The subclaims in that case relate to particularly advantageous developments of the invention.

The general inventive idea consists in actuating not only the selector contact unit, but also the switching means for the uninterrupted load changeover by a common motor drive without interposition of an energy accumulator.

According to a preferred form of embodiment the vacuum interrupters are arranged directly at a slide carriage of the respective selector contact unit and the motor drive drives a central threaded spindle, which is in operative connection with a plurality of slide carriages, by an angle transmission, wherein each slide carriage has a spindle nut and the threaded spindle co-operates with the spindle nut of each slide carriage and so converts the rotational movement into a synchronous longitudinal displacement of the plurality of slide carriages that both the movable selector contacts and the vacuum interrupters are thereby actuatable.

According to a further preferred form of embodiment of the invention the on-load tap changer comprises a transmission module that is fastened to the underside of the transformer cover and that co-operates with the motor drive arranged at the opposite outer side of the transformer cover. The transmission module has, for that purpose, a flange-like sealing module that is arranged directly at the underside of the transformer cover and that is detachably connected, in particular screw-connected, with the motor drive. In addition, the entire load changeover switch is fastened to the transmission module. The transmission module thus has not only the task of mounting the on-load tap changer, but also the task of sealing relative to the outer side of the transformer by the sealing module. Twistings of the transformer cover during transport of the transformer are thus not transmitted to the on-load tap changer. In addition, a connecting flange with milled-over sealing surface at the transformer cover can thus be eliminated. Beyond that, this form of proposed fastening offers to the transformer manufacturer simple mounting of the on-load tap changer within the transformer vessel.

According to yet a further form of embodiment of the invention the movable selector contacts are respectively received in a contact carrier and co-operate with fixed selector contacts that are arranged at a support plate, in such a manner that the individual fixed selector contacts are connectable by a longitudinal displacement of the movable selector contacts inclusive of the slide carriages, thus the selector contact unit, along the guide rod. By virtue of the movement of the selector contact unit to and/or fro the individual fixed selector contacts are connected and thus run through the regulating range of the on-load tap changer.

The invention and the advantages thereof are described in more detail in the following with reference to the accompanying drawings, in which:

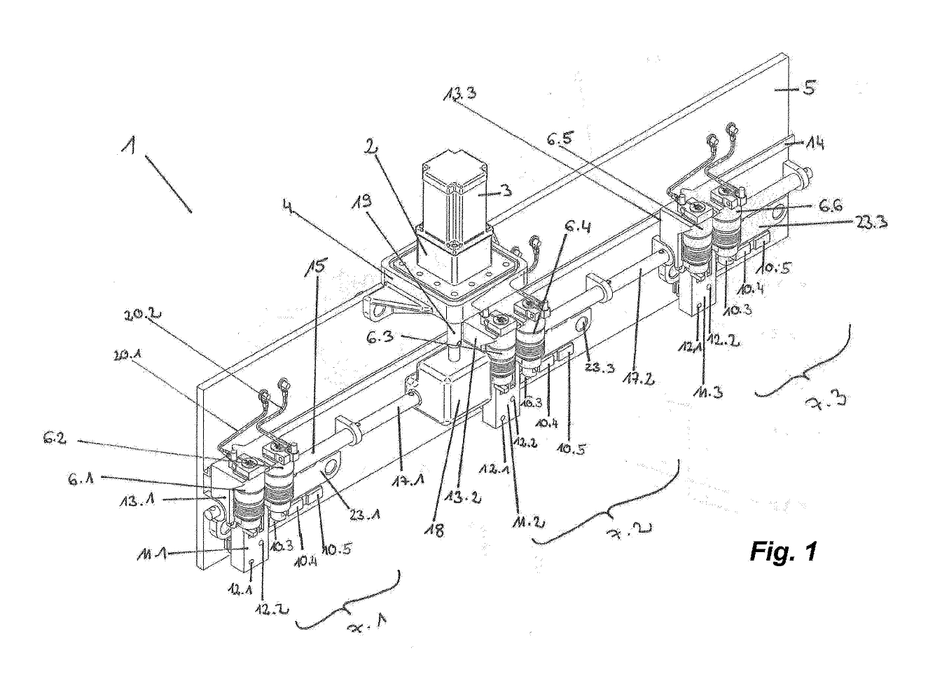

FIG. 1 shows a side perspective view of a [further] form of embodiment of an on-load tap changer according to the invention;

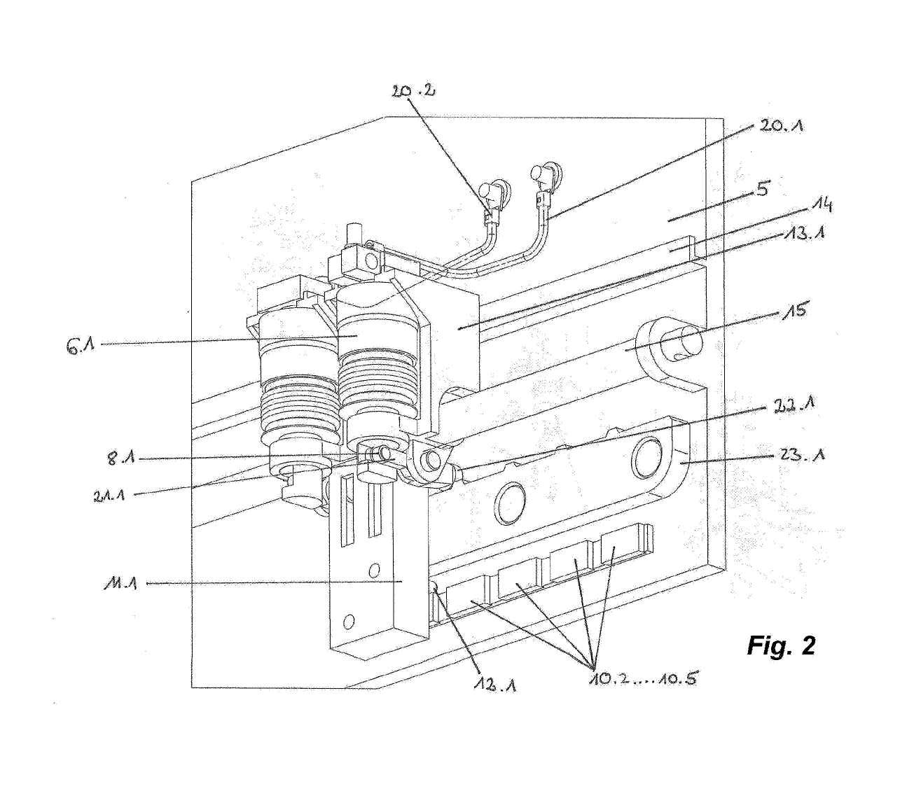

FIG. 2 shows a detail view of the side perspective view according to FIG. 1.

An on-load tap changer 1 according to the invention, which is arranged directly below a transformer cover (not shown) of a tapped transformer (similarly not illustrated in more detail), is shown in FIG. 1 in a perspective view. A more precise description of the components of the on-load tap changer 1 and the function thereof can be inferred from the description of the figures further below. A tapped transformer of that kind, which is well-known from the prior art, comprises a transformer vessel that is filled with insulating oil and in which at least one winding is arranged at an iron yoke. This winding is divided into a main winding and a regulating winding, at which a plurality of winding taps forming the regulating range is provided. In addition, the on-load tap changer comprises a transmission module 2 that is attached to the underside of the transformer cover and that co-operates with a motor drive 3 arranged at the opposite, outer side of the transformer cover. The motor drive 3 can in that case be constructed as, for example, a proprietary step motor. The transmission module 2 comprises a flange-like sealing module 4 that is arranged directly at the underside of the transformer cover and detachably connected, in particular screw-connected, with the motor drive 3. The entire on-load tap changer 1 is thus fastened to the transmission module 2. The transmission module 2 fulfils not only the task of mounting the on-load tap changer 1, but also the task of hermetically sealing relative to the outer side of the transformer by the sealing module 4. Consequentially, twistings of the transformer cover during transport of the transformer are not transmitted to the on-load tap changer 1.

Mechanically connected with the transmission module 2 is a support plate 5 of dielectric material, to which the individual subassemblies of the on-load tap changer 1 are fastenable. The support plate 5 is in that case made from electrically insulating material and constructed for the purpose of holding all significant components of the on-load tap changer 1. The on-load tap changer 1 according to the invention provides, as switching means for the uninterrupted changeover, vacuum interrupters 6.1 . . . 6.6, wherein in each instance two vacuum interrupters 6.1 and 6.2 or 6.3 and 6.4 or 6.5 and 6.6 are associated with a respective phase of the on-load tap changer 1 and co-operate with a corresponding selector contact unit 7.1 . . . 7.3. The vacuum interrupters 6.1 . . . 6.6 are switching means that are known from the prior art, with a movable switch contact 8.1 . . . 8.6 as well as a fixed contact 9.1 . . . 9.6 that is not illustrated in more detail. Each selector contact unit 7.1 . . . 7.3 comprises a respective plurality of connectable fixed selector contacts 10.1 . . . 10.5, which are electrically connected with the winding taps of the regulating winding of the tapped transformer, a contact carrier 11.1 . . . 11.3 with two respective resiliently mounted, movable selector contacts 12.1 and 12.2 as well as two respective vacuum interrupters 6.1 . . . 6.6 that are directly arranged at a corresponding slide carriage 13.1 . . . 13.3 of the respective selector contact unit 7.1 . . . 7.3. Regardless of the principle of switching, thus according to the reactor switching principle or resistance fast switching principle, in that case middle settings—in which one movable selector contact, for example the movable selector contact 12.1, is connected with the first fixed selector contact, for example the fixed selector contact 10.1, and the other movable selector contact, for example the movable selector contact 12.2, is connected with the second fixed selector contact, for example the fixed selector contact 10.2, adjacent to the first fixed selector contact—are permissible as stationary operational settings of the on-load tap changer 1. Thus, according to the reactor switching principle nine stationary operational settings are possible with the, here, five illustrated fixed selector contacts 8.1 . . . 8.5, whereas in the case of an on-load tap changer 1 according to the resistance fast switching principle, in which no middle settings are permissible, there are only five stationary operational settings.

In the illustration of FIG. 1 there are, by way of example, three selector contact units 7.1, 7.2 and 7.3; each selector contact unit 7.1, 7.2 and 7.3 is in that case connected with a separate phase, thus winding, of the tapped transformer. The contact carrier 11.1 . . . 11.3 of each phase is in that case mechanically fixed to a slide carriage 13.1 . . . 13.3 and forms together therewith a constructional unit. The slide carriage 13.1 . . . 13.3 is so mounted on a rail 14 as well as a threaded spindle 15, which is arranged parallel to the rail 14, that the individual fixed selector contacts 10.1 . . . 10.5 are connectable by a longitudinal displacement of the movable contacts 12.1 . . . 12.3 together with slide carriages 13.1 . . . 13.3 along the rail 14.

In this form of embodiment of the on-load tap changer 1 the switching means for the uninterrupted switching, thus the vacuum interrupters 6.1 . . . 6.6, are arranged directly at the corresponding slide carriages 13.1 . . . 13.3 of the respective selector contact unit 7.1 . . . 7.3 and are constructed to be movable together therewith along the threaded spindle 15. In this form of embodiment each selector contact unit 7.1 . . . 7.3 has its own spindle nut 16.1 . . . 16.3, which is not visible in this illustration and in which corresponding slide carriages 13.1 . . . 13.3 are arranged, so that the selector contact units 7.1 . . . 7.3 are thus constructed to be synchronously displaceable along the threaded spindle 15. The threaded spindle 15 is assembled from a plurality of elements and has between the corresponding elements a respective coupling tube 17.1 . . . 17.2 formed from an electrically insulating material. Also provided is an angle transmission 18 in order to pass on the rotational movement of the motor drive 3 to the threaded spindle 15. Arranged between the motor drive 3 and the angle transmission 18 is an insulating shaft 19 of dielectric material which introduces the rotational movement of the motor drive 3 into the angle transmission 18. The fixed contacts 9.1 . . . 9.6 of the vacuum interrupters 6.1 . . . 6.6 arranged at the corresponding slide carriages 13.1 . . . 13.3 are screw-connected by respective wires 20.1 . . . 20.6 to the carrier plate 5 and electrically connected with switch-over chokes or switch-over resistances (not illustrated). Switch-over chokes are provided in accordance with the reactor switching principle and switch-over resistances in accordance with the resistance fast switching principle. The movable switch contacts 8.1 . . . 8.6 of the vacuum interrupters 6.1 . . . 6.6 are disposed in mechanical operative connection with respective rocker arm arrangements 21. 1 . . . 21.6 that each have a roller 22.1 . . . 22.6. In the installed state of the on-load tap changer 1 the movable switch contacts 8.1 . . . 8.6 of the vacuum interrupters 6.1 . . . 6.6 are electrically connected with the movable selector contacts 12.1 . . . 12.2 of the associated phase. The corresponding rollers 22.1 . . . 22.6 roll along the profiling of a guide rail 23.1 . . . 23.3 when longitudinal displacement of the slide carriage 13.1 . . . 13.3 takes place, so that the respective rocker arm arrangement 21.1 . . . 21.6 thereby connects, i.e. opens or closes, the corresponding movable switch contact 8.1 . . . 8.6 of the associated vacuum interrupter 6.1 . . . 6.6 in dependence on the profiling of the guide rail 23.1 . . . 23.3. The fixed selector contacts 10.1 . . . 10.5, of which only the fixed selector contacts 10.3 . . . 10.5 can be seen in this illustration, are here directly arranged at the carrier plate 5 and electrically connected with the corresponding winding taps of the regulating winding of the tapped transformer on the opposite side, which is not illustrated here, of the carrier plate 5.

In summary, it can be emphasized that the on-load tap changer 1 according to the invention is thus usable not only in accordance with the reactor switching principle, but also in accordance with the resistance fast switching principle. Depending on the underlying switch-over principle nine stationary operational settings are permissible with the, here, five illustrated fixed selector contacts 10.1 . . . 10.5 in accordance with the reactor switching principle, whereas merely five stationary operational settings are permissible with an on-load tap changer 1 according to the invention constructed in accordance with the resistance fast switching principle.

The on-load tap changer according to the invention can be used with particular advantage at distribution transformers for voltage regulation of local mains.

### REFERENCE NUMERAL LIST

1 on-load tap changer
2 transmission module
3 motor drive
4 sealing module
5 support plate
6.1 . . . 6.6 vacuum interrupters
7.1 . . . 7.3 selector contact units
8.1 . . . 8.6 movable switch contacts
9.1 . . . 9.6 fixed contacts
10.1 . . . 10.5 fixed selector contacts
11.1 . . . 11.3 contact carriers
12.1, 12.2 movable selector contacts
13.1 . . . 13.3 slide carriages
14 rail
15 threaded spindle
16.1 . . . 16.3 spindle nuts
17.1, 17.2 coupling tubes
18 angle transmission
19 insulating shaft
20.1 . . . 20.6 wires
21.1 . . . 21.6 rocker arm arrangements
22.1 . . . 22.6 rollers
23.1 . . . 23.3 guide rails

1. In an on-load tap changer for uninterrupted switching between different winding taps of a tapped transformer, wherein
at least one selector contact unit with a respective plurality of fixed selector contacts, which are respectively electrically connected with the individual winding taps, is arranged along a line,
the fixed selector contacts are actuatable by two longitudinally displaceable movable selector contacts,
for the uninterrupted switching two vacuum interrupters are provided for each phase and
a motor drive for introducing a drive movement into the on-load tap changer is provided,
the improvement wherein:
the at least one selector contact unit and the switching means for the uninterrupted switching are so directly actuatable by the common motor drive that introduction of the drive movement of the motor drive into the at least one selector contact unit and the switching means for the uninterrupted switching takes place without interposition of an energy accumulator.

2. The on-load tap changer according to claim 1, wherein
two respective vacuum interrupters per phase are directly arranged at the corresponding slide carriage of the respective selector contact unit,
the motor drive drives a central threaded spindle by an angle transmission,
each slide carriage has a separate spindle nut and
the threaded spindle co-operates with the spindle nut of each slide carriage and the rotational movement is so convertible into a synchronous longitudinal displacement of the plurality of slide carriages that not only the movable selector contacts, but also the vacuum interrupters are thereby actuatable.

3. The on-load tap changer according to claim 1, wherein the entire load changeover switch is arranged by a transmission module at the underside of a transformer cover.

4. The on-load tap changer according to claim 1, wherein the transmission module comprises a flange-like sealing module.

5. The on-load tap changer according to claim 1, wherein a support plate of a dielectric material, at which the at least one selector contact unit and the switching means for the uninterrupted switching are arranged, is provided.

6. The on-load tap changer according to claim 1, wherein the at least one selector contact unit comprises a respective slide carriage, a respective contact carrier and respective movable selector contacts that co-operate with at least one fixed selector contact.

7. The on-load tap changer according to claim 1, wherein the movable selector contacts are each received in a contact carrier and co-operate with fixed selector contacts arranged at the support plate.

8. The on-load tap changer according to claim 1, wherein the movable selector contacts of a phase in each stationary operational setting connect at least one fixed selector contact of the same phase of the on-load tap changer.

9. The on-load tap changer according to claim 1, wherein in each instance two movable selector contacts are received in a contact carrier to be resiliently mounted.

10. The on-load tap changer according to claim 1, wherein the threaded spindle is of multi-part construction.

11. The on-load tap changer according to claim 1, wherein the plurality of parts of the threaded spindle are interconnected by coupling tubes to be secure against relative rotation.

12. The on-load tap changer according to claim 1, wherein the coupling tubes consist of dielectric materials.

13. The on-load tap changer according to claim 1, wherein the movable switch contact of the corresponding vacuum interrupter is so disposed in operative connection by a roller, which is provided at a corresponding rocker arm arrangement, with the profiling of a guide rail that through a longitudinal displacement of the selector contact unit the corresponding roller rolls along the profiling of the control link with maintained contact, so that the rocker lever arrangement connects the corresponding vacuum interrupter.

14. The on-load tap changer according to claim 1, wherein the control link is arranged directly at the support plate.

15. The on-load tap changer according to claim 1, wherein the control link and the support plate are constructed as one component.

16. The on-load tap changer according to claim 1 for use in voltage regulation of a distributing transformer.
